(19) United States
(12) Patent Application Publication
(10) Pub. No.: US 2010/0081486 A1
(43) Pub. Date: Apr. 1, 2010

(54) PORTABLE WIRELESS COMMUNICATION DEVICE

(76) Inventor: Justin C. Kim, Great Neck, NY (US)

Correspondence Address: GREENBERG TRAURIG, LLP, 200 PARK AVE., P.O. BOX 677, FLORHAM PARK, NJ, 07932, US

(21) Appl. No.: 12/238,881

(22) Filed: Sep. 26, 2008

(51) Int. Cl. H04M 1/00

(52) U.S. Cl. 455/575.1

(57) ABSTRACT

A portable communication device which has a built-in microphone and a speaker is provided for releasable connection to a multimedia player, for wirelessly transmitting playback signals that are receive from the multimedia player to an external multimedia receiver for playback thereon. The device can also wirelessly communicate with a wireless phone such that a user can make hands-free phone calls through the wireless phone with the use of the microphone and the speaker of the device.

### RELATED APPLICATION

This application is being filed concurrently with U.S. Non-provisional patent application Ser. No. ______ entitled “PORTABLE WIRELESS COMMUNICATION DEVICE” (Inventor Justin C. Kim; Attorney Docket No. 102655.010600), the entire disclosure of which is incorporated herein by reference.

### FIELD OF THE INVENTION

The present invention relates to wireless devices for use with multimedia players/receivers and communications units, and, more particularly, to wireless devices that facilitate hands-free operation of wireless communication units.

### BACKGROUND OF THE INVENTION

Cellular phones, portable digital multimedia players (e.g., MP3 players) and products that combine these units have been available for some time. Devices are also available that enhance the operation and functionality of such products. For example, headpieces that use the Bluetooth protocol are available to wirelessly connect with cellular phones to facilitate the hands-free operation of the cellular phones. Likewise, devices are available that use frequency modulation (FM) wireless protocol to broadcast multimedia playback signals to multimedia devices, such as automobile FM radio receivers.

### SUMMARY OF THE INVENTION

The present invention includes a communication device having a portable housing. The device also includes a processor housed in the housing and a transmitter housed in the housing for wirelessly transmitting first signals, which is received from an external audio player, to an external receiver in accordance with a first communication protocol such that sounds corresponding to the first signals can be produced by a speaker of the external receiver. A communication module (e.g., a transmitter) is also housed in the housing for wirelessly communicating with a wireless phone in accordance with a second communication protocol such that second signals associated with a phone call can be transmitted between the wireless phone and the processor.

### BRIEF DESCRIPTION OF THE DRAWINGS

For a more complete understanding of the present invention, reference is made to the following detailed description of an exemplary embodiment considered in conjunction with the accompanying drawings, in which:

FIG. 1 is a schematic block diagram of a wireless device according to an embodiment of the present invention, the device shown in connection with other electronic devices;

FIG. 2A is a front elevational view of the wireless device shown in FIG. 1;

FIG. 2B is a rear elevational view of the wireless device shown in FIG. 1;

FIG. 2C is a left-side elevational view of the wireless device shown in FIG. 1;

FIG. 2D is a top plan view of the wireless device shown in FIG. 1; and

FIG. 3 is a schematic block diagram illustrating various electrical/electronic components of the wireless device shown in FIG. 1.

### DETAILED DESCRIPTION OF THE INVENTION

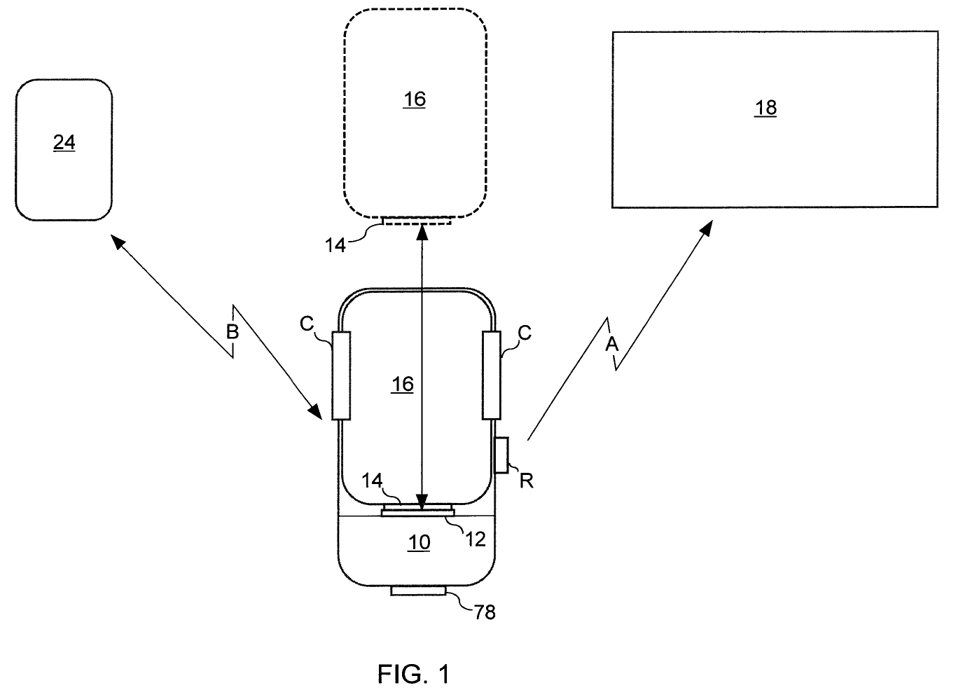

FIG. 1 illustrates a device 10 constructed in accordance with an exemplary embodiment of the present invention. The device 10 is adapted for use in conjunction with a variety of electronic units to integrate and improve the ease of use of the electronic units. More particularly, the device 10 includes a socket 12 (e.g., 30 pin connector) for removably connecting the device 10 to a socket 14 of a conventional multimedia player 16 (e.g., MP3 players, such as iPOD® devices, or cellular phones having audio playback functions, such as phones sold under the trademark iPhone). The player 16 may be held in place on the device 10 by two flexible clasps C located on the device, and the player 16 may be released from the device 10 by a release tab R located on the device 10. The device 10 can, when connected to the player 16 via the mating of sockets 12, 14, receive audio signals from the player 16 (hereinafter “playback signals”) and then wirelessly transmit or broadcast the signal (as indicated by Arrow A in FIG. 1) to a multimedia receiver 18 (e.g., an FM radio receiver) with the use of a first wireless modulation protocol (e.g., frequency modulation (FM) from 87.5 MHz to 107.9 MHz) for playback through the receiver 18 (e.g., through its speaker system).

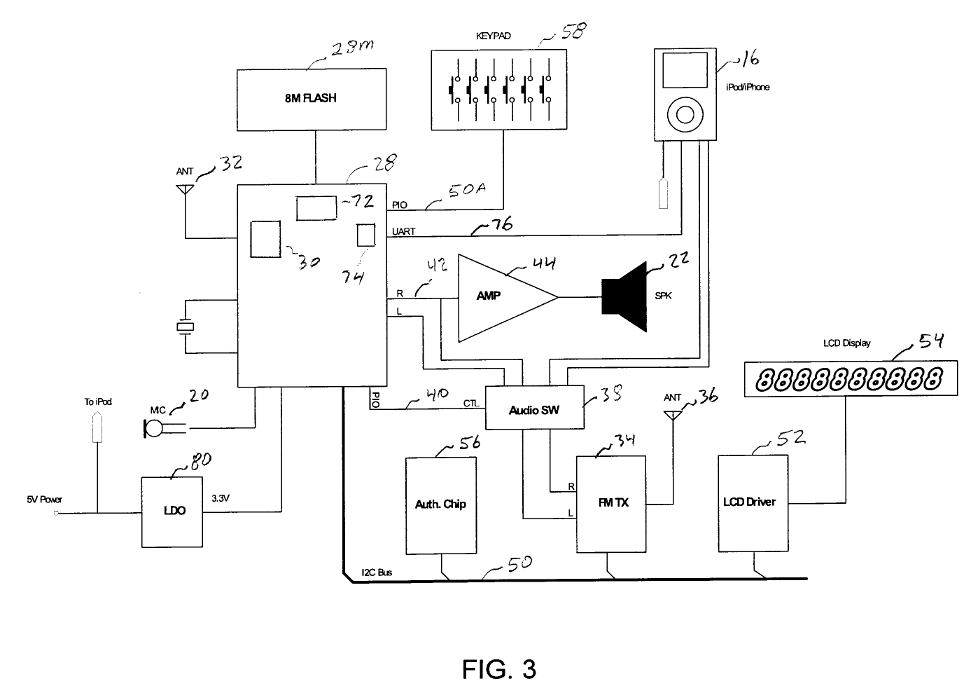

The device 10 includes a built-in microphone 20 and speaker 22 (see FIG. 3). The device 10 is adapted to wirelessly communicate with a cellular phone 24 through the use of a second wireless modulation protocol, such as Bluetooth with HFP and HSP profiles, (as indicated by Arrow B in FIG. 1) to transmit/receive signals to and from the cellular phone 24 for allowing a user to make hands-free cellular phone calls through the cellular phone 24.

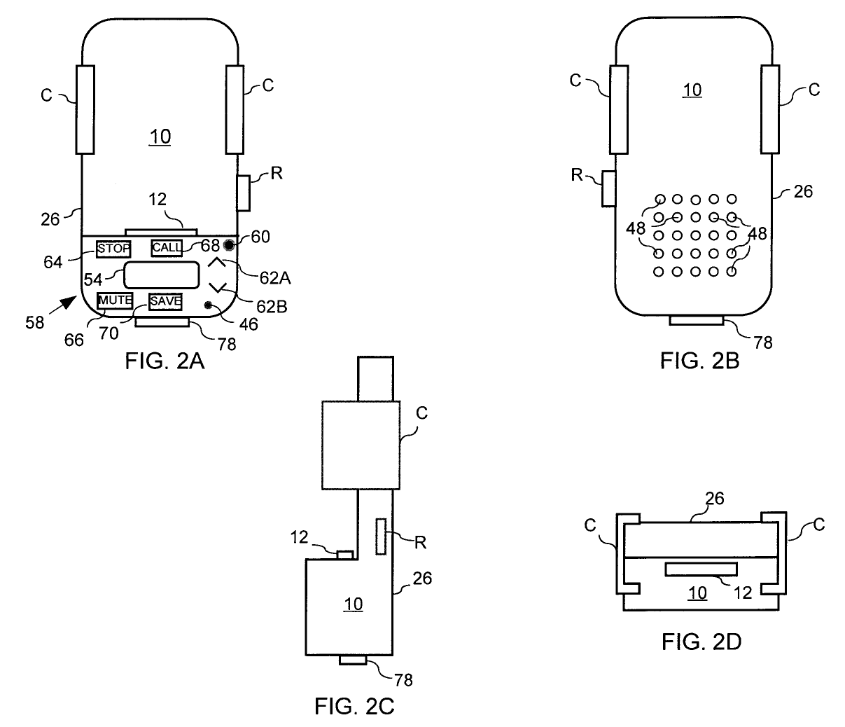

Referring now to FIGS. 2A-2D and 3, the device 10 has a portable housing 26, which is sized and shaped so as to be held in the hand of a user and which encloses therewithin a digital signaling processing engine (hereinafter “the processor”) 28 and flash memory 28M. The processor 28 includes a transceiver 30 (e.g., a 2.4 GHz radio for operation on the second wireless modulation protocol) and an antenna 32 for communicating with the cellular phone 24. The processor 28 supports the operation of the device 10 and the processing of signals received from/transmitted to the player 16 and/or the cellular phone 24. The housing 26 may have a mounting facility attached thereto, such as a suction mount (not shown), for removably fastening the device 10 to an object, such as an automobile windshield (not shown).

The device 10 also has a transmitter 34 which is positioned in the housing 26 of the device 10 and which is connected to an antenna 36. The playback signals produced by the player 16 are transmitted through an audio switch 38, which is controlled by the processor 28 through an input/output (PIO) circuit control line 40, to the transmitter 34 and antenna 36 for broadcasting same through the use of the first wireless protocol. The receiver 18 receives the signals transmitted from the transmitter 34 and antenna 36 and reproduces them on its the speaker system.

The device 10 receives or initiates cellular phone calls through the cellular phone 24. If during broadcasting playback signals the device 10 detects the receipt or initiation of a cellular phone call, the processor 28 signals the player 16 over the line 76 to pause the production of playback signals in order that the cellular phone call may be conducted. Likewise, when the cellular phone call is completed, the processor 28 signals the player 16 over the line 76 to resume the production of playback signals.

During a cellular phone call, the cellular phone call signals that are received on the antenna 32 are processed by the processor 28 and transmitted on a line 42 to an amplifier 44 for amplification and output on the speaker 22 of the device 10. User voice-wave signals generated by the microphone 20 and processed by processor 28 (e.g., for noise and echo cancellation, etc.) are transmitted by the transceiver 30 and antenna 32 and broadcast to the cellular phone 24. In this regard, the housing 26 has an orifice 46 for admitting the passage of sound-waves therein to the microphone 20, and a plurality of orifices 48 for permitting the passage of sound-waves generated by the speaker 22 to the exterior of the device 10.

Alternately, the cellular phone 24 may be equipped with a multimedia player such as an MP3 player (not shown) and the Bluetooth A2DP profile. In this mode, the cell phone may broadcast playback signals or cellular phone call signals to the device 10. In this instance, receipt of such signals by the processor 28 prompts the processor 28 to sends a signal on line 40 to the audio switch 38 to configure the audio switch 38 so that the signals received and processed by the processor 28 are transmitted on lines R and L through the audio switch 38 to the transmitter 34 for broadcast via the first wireless communication protocol through the antenna 36. The receiver 18 may receive the cellular phone playback or call signals and reproduce them on its the speaker system.

Continuing to refer to FIGS. 2A-2D and FIG. 3, the processor 28 also has an 12C bus 50, for facilitating the communication of control data signals between the processor 28 and elements of the device 10, such as the FM transmitter 34, an LCD driver 52 and an LCD display 54, and an authorization chip 56 (i.e., for support of specific player manufacture's features).

The device includes a keypad 58 which has, in addition to the LCD display 54, a variety of user interface controls such as a paring button 60 which initiates “pairing” (via the second wireless modulation protocol) between the device 10 and the cellular phone 24; call-mode volume up/down—player-mode channel search up/down buttons 62A, 62B; a call-reject or call-end button 64; a call-mode microphone mute/unmute-player-mode play/pause button 66; a call-accept/ voice-dialing/recent-received call list button 68, and a player channel-save/move-to-saved channel button 70. All of these user interface controls are positioned on the keypad 58 of the housing 26 (see FIGS. 2A-2B) and are all connected to the processor 38 on a line 50A. In this regard, the processor 38 also includes a microcontroller 72, for processing signals received from/sent to the user-interface controls of the keypad 58. The processor 38 includes a UART interface 74 that is connected to the socket 12 via a line 76 for control data exchange with the player 16 in a conventional manner. The device 10 has a connector 78 for a cable connection (not shown) to a power source (e.g., a 12 volt-DC cigarette lighter socket). The connector 78 is connected to a voltage converter/regulator 80 (e.g., a low dropout regulator (LDO)) for powering the device 10 and the player 16 in a conventional manner. The device 10 enables the user to conduct hands-free phone calls in a manner which is described in greater detail below.

In operation, signals generated by the use of the controls on the keypad 58 are transmitted to the microcontroller 72 of the processor 28 through the I2C bus 50 for processing by the microcontroller 72. In the player-mode, control signals generated by the processor 28 are transmitted to the player 16 via the UART interface 74 on the line 76, while playback signals (e.g., stereo audio music) generated by the play 16 are transmitted to the transmitter 34 through the audio switch 38 for broadcast via the first wireless communication protocol through the antenna 36. The signals broadcast through the antenna 36 are received by the receiver 18 and played back through its speaker system.

When the device 10 is paired with the cellular phone 24 by pressing the button 60, a cellular phone call may be received or initiated by the appropriate utilization of the button 68. If playback signals are being broadcast when the user receives or initiates the cellular phone call, the processor 28 may pause the player 16 by sending a pause signal to player 16 through the UART interface 74 on the line 76 so that the device 10 is able to communicate via the second wireless communications protocol with the cellular phone 24. More particularly, an incoming cellular phone call can be received by the antenna 32 and the transceiver 30 and processed by the processor 28 in a conventional manner. Caller identification information (CID) may also be conveyed to the LCD display 54 via the 12C bus 50. The user may, upon examining the CID, press the button 68 to accept the call. If the call is accepted, it is connected to the speaker 22 of the device 10. When the user speaks, his or her voice is received by the microphone 20 of the device 10 and converted into voice signals, which, in turn, are transmitted to the processor 28. The voice signals, after being processing by the processor 28, are transmitted to the transceiver 30 for broadcast by the antenna 32 to the cellular phone 24. Outgoing cell phone calls may be initiated from the device 10 by the appropriate use of the button 68 for voice-activated dialing or for recent-call redialing. Likewise, cellular phone calls may be terminated by appropriate use of the button 64. Upon termination of the cellular call, the processor 28 resumes operation of the player 16.

It should be noted that the present invention can have numerous modifications and variations. For instance, the component-elements described hereinabove may be replaced with elements that combined or separate the component-elements.

It will be understood that the embodiment described herein is merely exemplary and that a person skilled in the art may make many variations and modifications without departing from the spirit and scope of the invention. All such variations and modifications, including those discussed above, are intended to be included within the scope of the invention as defined in the appended claims.

What is claimed is:

1. A communication device comprising a portable housing; a processor housed in said housing; a transmitter housed in said housing for wirelessly transmitting first signals, which is received from an external audio player, to an external receiver in accordance with a first communication protocol such that sounds corresponding to said first signals can be produced through a speaker of the external receiver; and a communication module housed in said housing for wirelessly communicating with a wireless phone in accordance with a second communication protocol such that second signals associated with a phone call can be transmitted between the wireless phone and said processor.

2. The device of claim 1, wherein said housing is sized and shaped so as to be held in a hand of a user.

3. The device of claim 2, further comprising an internal speaker and a microphone housed in said housing for allowing a user to make the phone call through the wireless phone with the aid of said internal speaker and said microphone.

4. The device of claim 3, wherein said communication module includes a transceiver connected to said processor for transmitting and receiving said second signals to and from the wireless phone.

5. The device of claim 4, further comprising a connector attached to said housing for connection to a cable coupled to the external audio player such that said first signals can be transmitted from the external audio player to said transmitter.

6. The device of claim 5, further comprising an audio switch connected between said connector and said transmitter, wherein said first signals are transmitted from said connector to said transmitter through said switch.

7. The device of claim 6, wherein said switch is connected to said processor so as to receive from said processor and to transmit to said transmitter third signals received wirelessly by said transceiver from an external wireless audio player in accordance with said second protocol, said transmitter wirelessly transmitting said third signals to the external receiver such that sounds corresponding to said third signals can be produced through the speaker of the external receiver.

8. The device of claim 1, wherein said first protocol is a frequency modulation (FM) protocol; and wherein said second protocol is a Bluetooth protocol.

9. The device of claim 1, wherein said processor includes a plurality of user interfaces connected thereto.
